(19) United States
(12) Patent Application Publication
(10) Pub. No.: US 2001/0033767 A1
(43) Pub. Date: Oct. 25, 2001

(54) Casebound, semi-concealed wire spine journal

(76) Inventor: Bob Howes, Amherst, MA (US)

Correspondence Address: Bob Howes, 15 Jason Court, Amherst, MA, 01002, US

(21) Appl. No.: 09/739,128

(22) Filed: Dec. 18, 2000

Related U.S. Application Data
(60) Provisional application No. 60/174,790, filed on Jan. 6, 2000.

(51) Int. Cl. B42F 13/00

(52) U.S. Cl. 402/77; 402/73; 402/75; 402/70; 402/57

(57) ABSTRACT

This invention provides for a wire bound journal with a partially concealed spine. This invention offers a casebound journal cover having flexible hinges for forming the partially concealed spine portions. This invention provides for the formation of a hybrid cover hinge section for completely retaining the wire ring mechanism and works in concert with the spine and rear cover to entirely conceal the entire bottom portion of the wire and the entire orthogonally adjacent spine portion of the wire of such a semi-concealed wire spine journal. This invention offers such a semi-concealed construction where the front cover may be folded back into a substantially coincident position with the rear cover with zero hinge resistance from any of the hinge joints forming the spine and hybrid hinged cover portions.

This application is a formal patent application based on provisional patent application No. 60/174,790 filed Jan. 16, 2000.

### BACKGROUND OF THE INVENTION

This invention relates to wire bound journals and specifically to wirebound journals with partially concealed spines. This invention relates to casebound journal covers having flexible hinges for forming the partially concealed spine portions. This invention relates to the formation of a hybrid multi panel cover hinge section for entirely retaining the wire ring in the cover and works in concert with the spine and rear cover to entirely conceal the entire bottom portion of the wire and the entire orthogonally adjacent spine portion of the wire of such a semi-concealed wire spine journal. This invention relates to such a semi-concealed construction where the front cover may be folded back into a substantially coincident position with the rear cover with zero hinge resistance from any of the hinge joints forming the spine and hybrid hinged cover portions.

The invention relates to case bound journal covers wherein the cover is comprised of a multi-panel section of laminated and non-laminated sections and specifically to a casebound cover having a hybrid formation of a panel stiffened portion and an non-panel un stiffened portion. The invention relates specifically to such case bound journal covers comprising a first section forming a front cover portion having a laminated on panel stiffener, a second section hingedly attached to said first section comprising a non stiffened section formed by the attachment of a cover sheath and liner, a third section forming a spine, hingedly attached to said second section having a laminated panel stiffener, and a fourth section forming a rear cover, hingedly attached to said third spine portion comprising a stiffened section having a panel stiffener laminated therein.

Split cover wire books have previously been available offering zero resistance to folding the covers back on themselves. Partially concealed journal covers have also been available but have had other limitations including leaving undesirable parts of the ring exposed or offering resistance to folding back of the covers. Typically the spine has a hinged portion and has a first hole set and a second hole set for receiving the wire rings. In this case, the ring is not covered on the bottom or the orthogonally adjacent spine portion of the ring. Consequently, the ring is subject to stresses that can make the rings crush sideways. Partially concealed journal covers of a single material construction have been available where the cover has a hybrid formulation having a cover portion and a ring holding second cover portion, so the ring is contained in the face portion of the cover as in the case of the invention contained herein. These formulations have stiffness in the hinges that offer resistance in folding the cover back into a layflat position coincident with the rear cover. Further, there are limitations in the quality level of material that is available otherwise only to the casemaking process.

The novel or new aspect here is the formulation of the second cover portion for holding the rings in the face plane of the front cover as a non-stiffened portion formed naturally in the casemaking process by the gluing of the liner to the cover sheath directly. This results in a completely flexible cover portion which upon folding the front cover back to be coincident with the rear cover, allows for a zero resistance pivotal action by flexing as needed so that no spring action or resistance whatsoever is offered. The benefit of the stiff orthogonal spine is preserved, including the covering of the entire bottom and side ring exposures and offering a quality support system for preventing wire crushing, while at the same time offering the style of a top cover plane bound ring which offers zero resistance to the folding back of the covers, a feature attributed previously to only split cover wire book formulations.

The invention relates to the delivery of such a semi concealed wire journal formed with a case bound construction in which a variety of quality cover materials are employed as the cover sheath, and in which a quality liner may also be employed for sealing the interior face panel of the case bound device.

### SUMMARY OF THE INVENTION

The invention therefore relates to the construction of a panel stiffened journal cover where the panels are glued between a liner and a cover sheath, where the cover sheath edges are turned over the stiffener inserts when placed therein, and where the liner is then glued onto the top of the turned edges and to any sections of the cover sheath where panels are absent to make a multi-panel cover assembly with a portion of stiffened panels, at least one non-stiffened panel portion forming a section of the hybrid cover, and a series of joined hinges formed between the panels and constructed by the gluing of the liner to the cover sheath to form a parallel hinge axis.

It is the object of this invention to provide such a semi-concealed journal cover as a case made construction formed from a paper liner, chipboard stiffener panels, and a fabric cover sheath.

It is a further object of this invention to provide for such a semi-concealed cover as a case made construction formed from other quality materials including tyvec liners, flexible panel stiffeners made from rubber like material or plastic, and laminated paper covers or vinyl coated paper covers with any varied patterns and graphics thereon.

In accordance with this invention, what is provided is(see detailed description of the invention).

### BRIEF DESCRIPTION OF THE DRAWINGS

The above and other objects and advantages of the invention will be apparent from consideration of the following detailed description, taken to conjunction with the accompanying drawings, in which like reference characters refer to like parts throughout, and in which:

FIG. 1 A perspective drawing of the case bound semi concealed wire journal

FIG. 2 An exploded view of the casebound journal of FIG. 1

FIG. 3 A cross sectional view of the side of the case bound journal of FIG. 1

FIG. 4 The journal of FIG. 1 in full open position

FIG. 5 The journal of FIG. 1 open full back with covers coincident one with the other

### DETAILED DESCRIPTION OF THE INVENTION

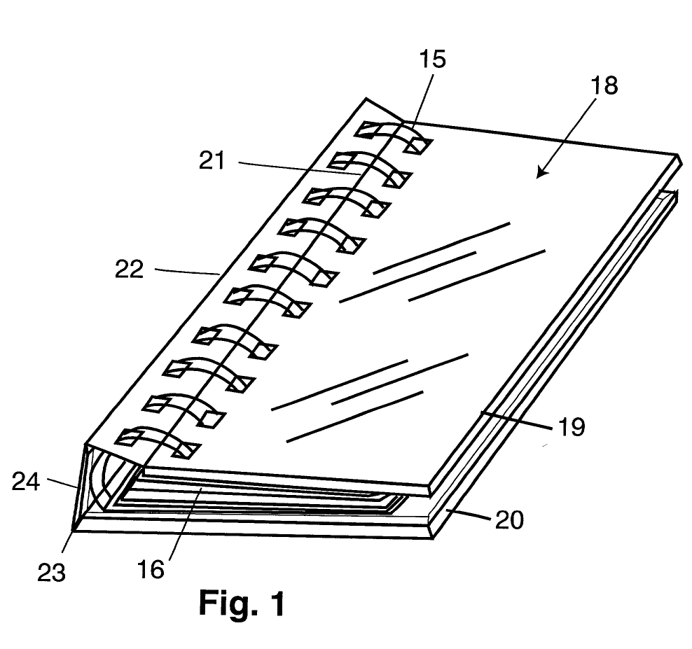

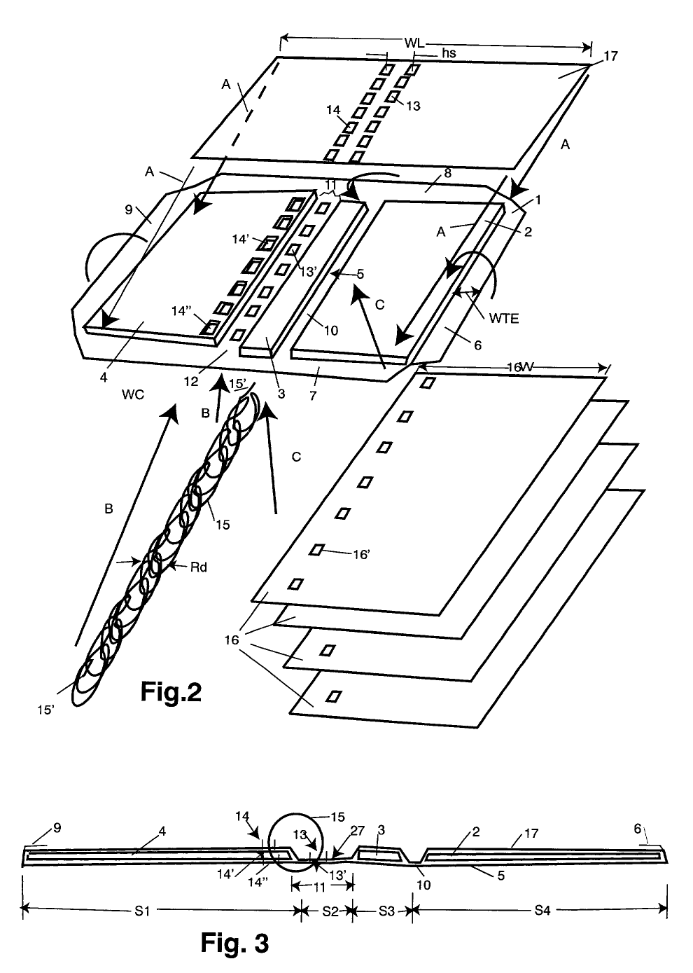

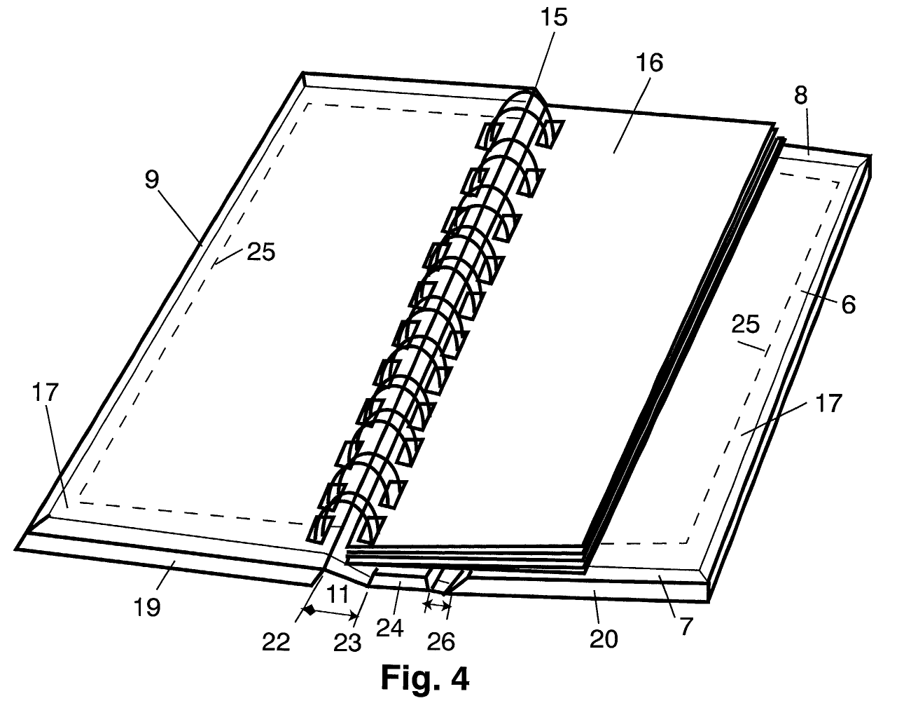

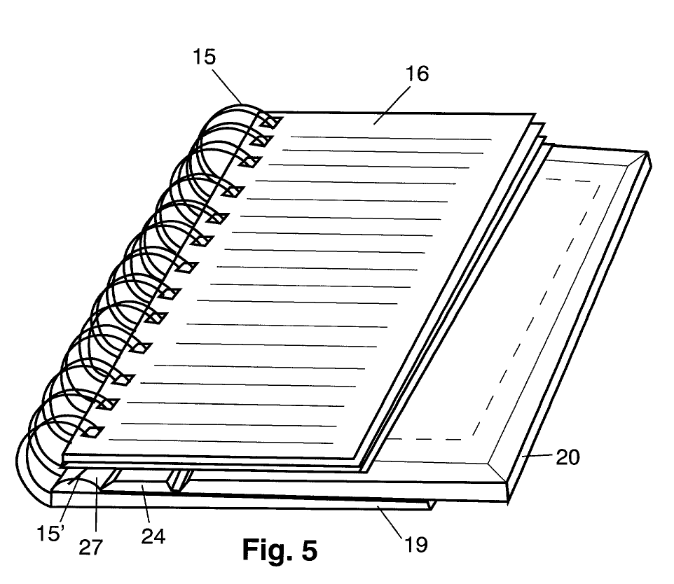

A preferred embodiment of the invention is shown in FIG. 1,2 and 3. The combination of these figures permits the best detailed description. A journal cover sheath,1, is laid out for assembly of a case made journal of the construction according to this invention. The cover has turn edge portions 6,7,8, and 9 with cut corners so that a neat fold can be formed at each corner. The turned edges have a width, wte, sufficient to cover the panel stiffeners and glue up and over such that the predetermined width of the liner wl, substantially covers them when the liner is attached by action A. The cover has a predetermined width capable of receiving a set of panels and a liner. Glued to this cover are three panel sections, 2,3, and 4. These panels form the rear cover, the spine and a portion of the front cover of the journal. Sufficient space,12, of width 11 is left between the front panel,4, and the spine 3, to form the hybrid hinge panel portion of the front cover which together with the hole in the section 11, holes 13′ and the holes in the cover 14″ and the panel 14′, hold the wire rings 15. The rear panel is laid up adjacent the spine leaving a gap 5 for the formation of hinge 23. The hinge is formed when the liner 17, is glued to the sheath 1 and to its respective panel sections. In any portion where no panel is present, the liner attaches directly to the cover sheath forming respectively the flexible cover portion 12 and the hinges 21, 22, and 23. Once the cover assembly is formed by action A, the double wire rings are inserted by action B, the pages,16, are attached and the rings, 15 are pressed closed. Sections S1 and S2 form the cover, and the ring 15 is contained entirely in the hybrid front cover portion. The various holes are punched to line up and hold the rings in place. The holes are shown in the explosion after any such punching operation is completed. Section S3 forms the protective spine that sits orthogonal to the rear cover and assists in preventing the rings from getting crushed. The predetermined diameter of the ring, Rd, determines the predetermined separation of the holes 13 and 14, hs. This distance is substantially the diameter of the rings. The Sum of the widths of sections 1 and 2 is substantially the width of the base rear cover S4. The width of the spine panel S3 is substantially the diameter of the ring that is selected based on the height of the number of leaves 16 which are to be contained therein. The width of section S2 is selected to be substantially the diameter of a closed ring set and the hole 13′ is situated middling this section S2. The square holes are sized to loosely contain the double wire and are typically square in formation although other shapes, such as round, can be used. The adjoining hole set 14′ is punched into the front cover at a distance determined by the predetermined diameter of the ring 15, and forms a hole set substantially adjacent to the cover hinge 21. The hole sets straddle hinge 21 resulting in the rings being contained completely in the cover. Section 27 is completely flexible, and as a result, can flex back naturally causing no resistance as the cover is opened and subsequently turned completely back on itself. The remaining parts and their purpose are contained in the following list.

One can form the panel stiffeners from chipboard of sufficient thickness to yield a relatively stiff, quality cover. 30 to 40 thousandths of an inch in thickness provide the likely minimum, although lighter weight or heavier weight are practical for different applications. Stiffeners can be flexible material if a pliable book construction is desired. Various liner and cover materials can offer different levels of quality, application appeal, and price without changing the fundamental advantage offered by this invention.

| FIG. | PART | WHAT |
|---|---|---|
| 2 | 1 | journal cover sheath |
| | 2 | rear cover portion laminate on panel stiffener |
| | 3 | spine portion laminate on panel stiffener |
| | 4 | front cover portion laminate on panel stiffener |
| | 5 | flexible hing portion between rear and spine panels |
| | 6 | right turn edge flap of journal cover sheath |
| | 7 | bottom turn edge flap of journal cover sheath |
| | 8 | top turn edge flap of journal cover sheath |
| | 9 | left turn edge flap of journal cover sheath |
| | 10 | unlaminated journal cover sheath portion forming |
| | | flex hinge 23 |
| | 11 | width of unlaminated front cover hinge portion |
| | 12 | unlaminated journal cover sheath portion forming |
| | | front cover hinge portion |
| | 13 | second hole in liner for receiving wire rings 15 |
| | 14 | first hole in liner for receiving wire rings 15 |
| | 13′ | first hole in journal cover sheath for receiving |
| | | wire rings |
| | 14″ | second hole in journal cover sheath for receiving |
| | | wire rings |
| | 14′ | second hole in front cover panel stiffener for |
| | | receiving wire |
| | 15 | wire spine for holding leafs 16 |
| | 15′ | end portion of wire spine 15 |
| | 16 | leafs of predetermined width 16w |
| | 16w | predetermined width of leaf 16 |
| | 16′ | hole for receiving wire ring |
| | 17 | liner for covering turned edge flaps 6, 7, 8, and 9 |
| | | and for sealing interior face of front, spine and rear cover |
| | | portions |
| | w1 | predetermined width of liner |
| | wc | predetermined width of cover from edge to edge |
| | wte | predetermined width of turned edge flaps for folding |
| | | over and gluing to panel portions of covers and spines |
| | A | placement of liner onto cover after cover sheath is |
| | | laminated and edges are turned |
| | B | insertion of wire ring spine into cover assembly |
| | | after liner is sealed in place |
| | C | attachment of leafs to wire rings after which wires |
| | | are closed |
| | hs | hole width separation |
| | Rd | predetermined ring diameter |
| 3 | 27 | double material only front cover hinge portion |
| | S1 | front cover section |
| | S2 | front cover hinge section |
| | S3 | spine section |
| | S4 | rear cover section |
| 1 | 18 | case bound semi concealed journal assembly |
| | 19 | front cover assembly |
| | 20 | rear cover assembly |
| | 21 | first front cover hinge axis between cover panel and |
| | | unlaminated front cover hinge portion |
| | 22 | second front cover hinge axis between unlaminated |
| | | front cover hinge portion and spine panel |
| | 23 | third hinge portion between spine panel and rear |
| | | cover panel |
| | 24 | spine assembly |
| 4 | 25 | turned edge “bulge” through liner |
| | 26 | space width of hinge 24 formed by unlaminated double |
| | | material seal between liner and cover sheath |
| 5 | 27 | front cover hinge portion assembly flexed or cover |
| | | back open position |

What is claimed is:

1. Semi-concealed casebound wire journal cover having a cover sheath and a liner and a set of panel stiffeners between including a front cover panel stiffener, a spine panel stiffener, and a rear cover panel stiffener, comprising a first section hingedly attached to a second section, hingedly attached to a third section, which is hingedly attached to a fourth section, wherein the first section is a front cover portion comprised of a panel stiffener glued between the cover sheath and the liner, the second section is a second front cover portion comprised solely of a glued liner and cover sheath, a third section is a spine section comprised of a spine panel stiffener glued between said liner and said cover sheath, and a fourth section as a rear cover comprising a rear cover panel glued between said liner and said cover sheath, wherein a series of hinges is thereby formed between said front cover panel, said second front cover portion, said spine, and said rear cover where said hinges comprise the glue line formed between said liner and said cover sheath between any of said panel stiffeners, and where said hinges so formed provide substantially zero resistance to the turning of the covers from full open to full folded back positions.

2. A Semi-concealed casebound wire journal cover comprising the combination of a cover having a cover sheath and a liner and a set of panel stiffeners between including a front cover panel stiffener, a spine panel stiffener, and a rear cover panel stiffener, comprising a first section hingedly attached to a second section, hingedly attached to a third section, which is hingedly attached to a fourth section, wherein the first section is a front cover portion comprised of a panel stiffener glued between the cover sheath and the liner, the second section is a second front cover portion comprised solely of a glued liner and cover sheath, a third section is a spine section of predetermined width substantially the diameter of a predetermined wire spine to be contained therein, comprised of a spine panel stiffener glued between said liner and said cover sheath, and a fourth section as a rear cover comprising a rear cover panel glued between said liner and said cover sheath, wherein a series of hinges is thereby formed between said front cover panel, said second front cover portion, said spine, and said rear cover where said hinges comprise the glue line formed between said liner and said cover sheath between any of said panel stiffeners, and where said hinges so formed provide substantially zero resistance to the turning of the covers from full open to full folded back positions, in combination with a wire ring of predetermined width, wherein said leaves are of a predetermined width such that said leaves fit within said covers when said wire ring is attached to said front cover, said leaves attached to said wire, and said covers are closed.
